(19) United States
(12) Patent Application Publication
(10) Pub. No.: US 2025/0094240 A1
(43) Pub. Date: Mar. 20, 2025

(54) CONGESTION CONTROL FOR AUTOMATIC COMPUTE CAPACITY SATURATION

(71) Applicant: Microsoft Technology Licensing, LLC, Redmond, WA (US)

(72) Inventors: Wenbin MENG, Bellevue, WA (US); Hemant KUMAR, Bellevue, WA (US); Rakesh KELKAR, Bellevue, WA (US); Karthik RAMAN, Sammamish, WA (US); Sanjay RAMANUJAN, Sammamish, WA (US); Kevin Joseph RIEHM, Woodbury, WA (US); Theodore Dragov TODOROV, Seattle, WA (US)

(21) Appl. No.: 18/470,795

(22) Filed: Sep. 20, 2023

(51) Int. Cl. G06F 9/50

(52) U.S. Cl. CPC G06F 9/5083; G06F 9/5044; G06F 9/5072

(57) ABSTRACT

A disclosed method facilitates an increase in utilization with respect to a resource quota allocated to a tenant from a shared resource pool. The method includes transmitting a lease request to a quota service on behalf of the tenant, where the lease request identifies a processing task and specifies quantity of cloud-based resources requested from the shared resource pool for execution of the processing task. The method further provides for determining, based on a feedback signal received from the quota service, whether grant of the lease request would cause the tenant to exceed a resource quota allocated to the tenant and dynamically decreasing parallelism of active tasks being processed by the cloud-based resources on behalf of the tenant in response to determining that grant of the lease request would cause the tenant to exceed the resource quota limit.

### BACKGROUND

Certain types of trained machine learning model, such as transformer models, consume significant amounts of memory. Examples of transformer-based models include GPT (Generative Pre-trained Transformer), OPT (Open Pretrained Transformer), and Bloom language model (Bioscience Large Open-science Open-access Multilingual). It is common for transformer models to be provided to end customers as cloud-based software services. The significant graphics processing unit (GPU) utilization of these models makes them expensive to operate and creates challenges pertaining to efficient resource management.

### SUMMARY

According to one implementation, a method provides for transmitting a lease request to a quota service on behalf of a tenant to a shared resource pool. The lease request is associated with a processing task and specifies a quantity of cloud-based resources requested from the shared resource pool. The method further provides for determining, based on a feedback signal from the quota service, whether grant of the lease request would cause the tenant to exceed a resource quota limit allocated to the tenant and dynamically decreasing parallelism of active tasks resources on behalf of the tenant in response to determining that grant of the lease request would cause the tenant to exceed the resource quota limit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that implements congestion control for automatic saturation of compute resource quotas allocated from a shared resource pool.

FIG. 2A illustrates quota management operations performed within an example system that dynamically adjusts task parallelism to achieve congestion control and automatic saturation of compute resource quotas allocated from a shared resource pool.

FIG. 2B illustrates congestion control operations performed in response to the actions illustrated and described with respect to FIG. 2A.

FIG. 2C illustrates congestion control operations performed in response to the actions illustrated and described with respect to FIGS. 2A and 2B.

FIG. 3 illustrates additional quota management actions within another example system that dynamically adjusts task parallelism to achieve congestion control and automatic saturation of compute resource quotas allocated to tenants in a shared resource system.

FIG. 4A illustrates a plot illustrating temporal changes in concurrent request transmission rate from a tenant device submitting jobs to a large cloud-based AI model.

FIG. 4B illustrates resource utilization costs for various exemplary workloads of the tenant device that are characterized by the concurrent request transmission rate trends shown in FIG. 4A.

FIG. 5 illustrates example congestion control operations for automatic saturation of compute resource quotas allocated to a shared resource pool.

FIG. 6 illustrates an example schematic of a processing device suitable for implementing aspects of the disclosed technology.

### DETAILED DESCRIPTION

The high cost and scarcity of GPU resources dramatically increases the cost of deploying trained machine learning models, including transformer models that perform natural language processing tasks. In existing systems that do deploy trained machine learning models as cloud-based services, compute resources are often pooled and dynamically assigned to cloud tenants (e.g., development teams or requesting applications) on an as-needed basis. Each cloud tenant is allocated some resource quota representing a fractional share of the pooled compute resources supporting the model. In some implementations, a different pool of resources supports each different instance of the trained machine learning model. In other implementations, one or more pools of compute resources are shared across different instances of the trained machine learning model deployed at the same or different data centers.

To mitigate operational costs, it is desirable to maximize GPU utilization to the extent possible. In the context of systems that impose compute resource quotas on individual tenants, it is therefore desirable to implement measures that help ensure that the allotted quota for each tenant is saturated (e.g., nearly fully utilized, as is discussed further below) at each point in time. On a larger scale, it is to be appreciated that saturation of quotas allotted to tenants sharing a pool of resources helps to further utilization (to at or near saturation) of the entire pool. Assuming that the tenant generates and submits enough jobs to collectively saturate the quota, the problem becomes one of concurrency management. That is, how many concurrent tasks need to be executed on behalf of the tenant to maximize the tenant's utilization of its allotted quota?

Saturating a tenant's assigned quota entails continuously identifying groups of parallelizable tasks (e.g., tasks that can be executed concurrently) that are characterized by specific combinations of compute capacity sizes (e.g., relative “compute cost” of each task) that collective sum a total “compute cost” that is at or near the quota. This objective of quota saturation becomes even more complicated and difficult to maintain when a tenant elects to run multiple batch jobs at once. Batch jobs are distributed programs that send requests concurrently across many processes and machines. In scenarios where a tenant has queued up multiple batch jobs for execution, selecting groups of tasks to concurrently execute can have the effect of prioritizing one pending batch job over another-sometimes in a manner contrary to the tenant's preferences. For throughput-sensitive and latency-sensitive workloads in particular, a client may prefer to give equal preference to all pending workloads. This is not feasible with existing quota management solutions that largely provide static configurations for managing task parallelism, requiring manual tuning of job concurrency in response to changes in capacity usage to ensure fair and consistent distribution of quota.

Further complicating the objective of quota saturation is the reality that a tenant's actual quota can dynamically change at any given time such as due to compute resources being repurposed, needing to be serviced, etc. In view of this, static configurations are insufficient to guarantee saturation of the compute resources in a tenant's allotted quota.

Embodiments of the herein disclosed technology include a quota management solution that facilitates automatically and dynamically re-scaling a number of concurrently-active workload tasks in a continuous (ongoing) manner in order to guarantee quota saturation. In one implementation, “quota saturation” refers to utilization that is at about 95% or more of a tenant's assigned quota. Likewise, a pool of compute resources is, in one implementation, “saturated” when about 95% or more of that pool is being utilized. The disclosed scaling methodology providing dynamic, self-attuning adjustments to task parallelism within each individual tenant workload in a manner that ensures resource utilization is maintained near a target (e.g., the full quota) for the tenant, thereby providing significant compute efficiency gains by increasing total utilization of resources in a shared resource pool. In addition, the disclosed scaling methodology also promotes fair-sharing of quota bandwidth between different workloads of a tenant, thereby minimizing execution latencies and increasing throughput across the board. This “fair-sharing” benefit ensures no workload is unfairly penalized by a larger workload being concurrently executed on behalf of the same tenant, which in turn decreases the maximum latency experienced by a tenant waiting for a given workload to execute.

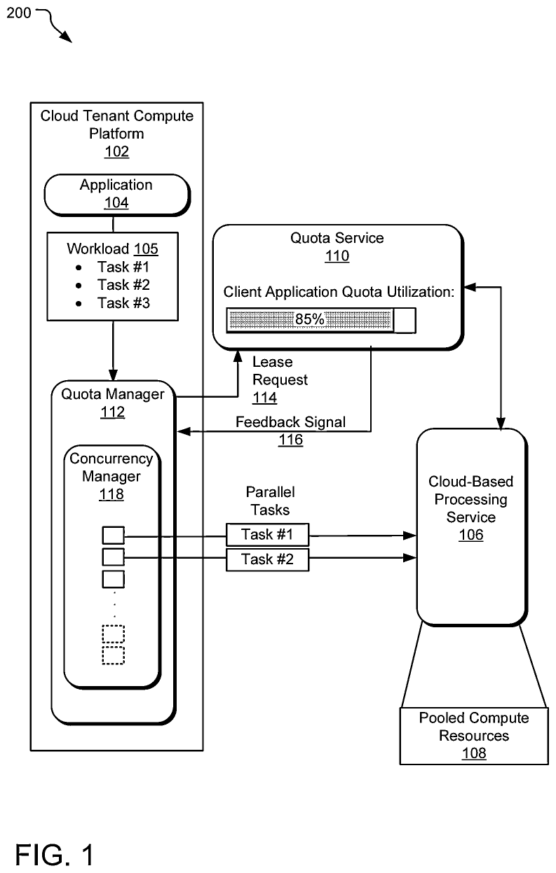

FIG. 1 illustrates an example system 100 that implements congestion control for automatic saturation of compute resource quotas allocated from a shared resource pool. The system 100 includes a cloud tenant compute platform 102 executing an application 104 that generates workloads (e.g., a workload 105) that are to be submitted to and executed by a cloud-based processing service 106 using resources pooled compute resources 108 shared among multiple cloud tenants. The cloud tenant compute platform 102 is a platform configured to perform compute tasks for a single tenant that utilizes the pooled compute resources 108 and may be understood as including cloud hardware and/or edge devices (e.g., personal devices) that communicate cloud hardware. In another implementation, the cloud tenant compute platform 102 is implemented entirely by edge device hardware on-premise at a facility owned by the tenant.

Each workload (e.g., the workload 105) generated by the application 104 includes certain “parallelizable tasks” can be performed concurrently and completely independent of one another. A batch job is one example of a workload with many parallelizable tasks. Typically, a batch job entails performing a set of common processing operations on each of multiple files, and the processing on each file can be performed without affecting the processing any other one of the individual files. Another example of workload with parallelizable tasks is a language translation task that requests translation of a book from English to Chinese. Different paragraphs or sections of the book can be translated in parallel because they have no logical dependence upon one another.

In various implementations, either the quota manager 112 or the application 104 executes logic to identify which tasks of the workload 105 are parallelizable. This logic includes rules that dictate the type(s) of tasks that may be processed in parallel, such as either as rules defined by developer(s) or logic that analyzes the dependencies of the various tasks since the outcome of processing a parallelizable task does not influence processing of another parallelizable task. In some implementations, the logic for identifying parallelizable tasks includes generating a prompt that is submitted to the cloud-based processing service 106 to suggest which portions of a given workload which can be parallelized. For example, the prompt is transmitted to one or more instances of a trained machine learning model executed by the cloud-based processing service 106, and the results are used to identify portions of the workload to be parallelized.

The cloud-based processing service 106 is, in one implementation, a service that supports instances of a trained machine learning model, such as a transformer model that performs NLP tasks. Each instance of the trained machine learning model is supported by one or more model endpoints distributed across various geographic regions. As used herein, a “model endpoint” refers to a server hardware, typically implemented on one or multiple virtual machines or servers configured to execute compute logic of a trained machine learning model. In one implementation, a model endpoint includes a collection of logical endpoints corresponding to one or more servers or one or more virtual machines executing on servers at a regional data center that are all configured to execute core logic of a trained machine learning model. In some systems, a single server has the capability to operate a plurality of model endpoints for different model instances (e.g., either the same model or different models). In one implementation, a model endpoint includes single instance of a model and the compute hardware supporting execution of that instance. In implementations where the cloud-based processing service 106 includes multiple model endpoints, the system 100 may further include load balancing logic (not shown) for selecting which of the multiple model endpoints is to receive each outgoing task.

The pooled compute resources 108 include central processing units (CPUs) and/or graphics processing units (GPUs) that are shared by various tenants that utilize the cloud-based processing service 106. In various implementations, the pooled compute resources 108 include resources at a same model endpoint (e.g., a same data center) or multiple different model endpoints. Each tenant to the pooled compute resources 108 is allocated a quota which is, for example, a percentage of the resources in the pool. In various implementations, the size of the quota allocated to each tenant is variable and, in some implementations, is determined based on a subscription tier that the tenant subscribes to or other factors. In some scenarios, allocated quotas change dynamically. If, for example, a data center decides to repurpose 50 servers previously serving a particular model, this results in a reduction of the size of the pooled compute resources 108 and may necessitate changes to the maximum compute capacity that is available to each tenant.

In FIG. 1, a quota service 110 communicates with the cloud-based processing service 106 to monitor compute capacity characteristics of the pooled compute resources 108, such as the total compute capacity in the pool and the available compute capacity, both of which are subject to change over time. In system where the cloud-based processing service 106 includes multiple model endpoints, the quota service 110 communicates with each of the endpoints to retrieve measurements of the current compute capacity characteristics of those endpoints. The quota service 110 also tracks utilization of the pooled compute resources 108 and performs operations for quota enforcement on behalf of each tenant.

The tenants to the pooled compute resources 108 can, in various implementations, be applications (e.g., the application 104), development teams, enterprises, etc. In one example, the cloud compute platform 102 includes a cloud-based server configured on behalf of a research team of data scientists. The cloud-based server receives batch jobs submitted by the data scientists. Assume, for example that a data scientist wants to examine the sentiment of 10,000 survey responses. This is done by submitting a batch job to a server of the cloud tenant compute platform 102, which runs a batch job driver (e.g., the application 104). The batch job driver begins downloading those 10,000 articles and then starts sending them to a trained machine learning model for processing. In this example, the sentiment analysis for each different article is a parallelizable task.

Notably, a tenant to the pooled compute resources 108 may be an enterprise, development team, or a specific application. For example, an enterprise is allocated a compute quota from the pooled compute resources 108 and the enterprise submits workloads for cloud processing that are generated by many different applications. The cloud-based processing service 106 receives and processes these workloads, all of which share the same quota of resources allocated to the enterprise. Alternatively, the tenant could be an application, such as prompt experimentation platform for a transformer-type language model that is used by various data scientists associated with different enterprises. The data scientists submit new prompt ideas and test data to the platform and, in return, the platform generates and submits batches of processing requests to the model using the new prompt format and input data.

For each individual one of the parallelizable tasks that the quota manager 112 receives, the quota manager 112 transmits a lease request 114 to the quota service 110. The lease request 114 is a request to reserve a share of the pooled compute resources 108 that are to be used to support execution of the task. In one implementation, the lease request identifies the requesting tenant (e.g., the application 104 or the enterprise or team that has been assigned a set quota) and also specifies a cost parameter corresponding to a net resource utilization of the task. As used herein, the “net resource utilization” for a given task refers to a quantity of resources that is tied up (“consumed”) during processing of the task. If allocated to identical processing hardware with access to identical memory resources, a task with a smaller net resource utilization is executed in a shorter amount of time than a task with a larger net resource utilization.

In one implementation where the task requested is a natural language processing (NLP) task executed by a large language (LLM), the net resource utilization of a task corresponds to a sum of the number of words being input to the LLM and the total number of words that the LLM is predicted to output based on the processing of the input words. The output number of words can, in various implementations, be estimated in different ways. In one implementation, the application 104 and/or quota manager 112 is configured to select a set output size based on the nature of the task requested and/or the inputs. For example, the set output size is selected from a predefined table created by the tenant or the LLM developer, such as based on the identity of the LLM and input parameter(s). In one implementation, the set output size represents a max cap on the size of the output.

In response to receiving the lease request 114, the quota service 110 retrieves current compute capacity characteristics of the pooled compute resources 108 including, for example, a current quantity of compute resources are in the pool, an identification of where available capacity resides, and of how much available capacity resides in each location. The quota service 110 further determines the quota that the requesting tenant has been allotted (e.g., the maximum concurrent resource utilization for the tenant) and also determines the fraction of that quota that is currently being used utilized by other tasks being processed on behalf of the requesting tenant. With this information, the quota service 110 determines whether grant of the lease request 114 would cause the utilization of the requesting tenant to exceed the tenant's allotted quota. If so, the quota service 110 denies the lease request 114. Otherwise, the lease request 114 is granted. The quota service 110 transmits a feedback signal 116 that indicates whether the lease request has been granted or denied. When the lease request 114 is denied, the feedback signal 116 includes an overload indicator. In one implementation, the overload indicator is an HTTP 429 signal. When the lease request 114 is granted, the feedback signal 116 does not include the overload indicator. For example, the feedback signal 116 may instead include a successful acknowledgement (ACK) from the quota service 110.

Over a period of time, the quota manager 112 observe the feedback signals, such as the feedback signal 116, and evaluates-based on the overload indicator(s) present in the feedback signals-whether overload criteria is satisfied. In one implementation, the overload criteria is satisfied when a threshold number of the overload indicators are received with respect to a given workload in a set period of time. When the overload criteria is satisfied with respect to a given workload evaluated over a time interval, the concurrency manager 218 performs an action effective to scale-down parallelism for processing the tasks of the workload. When the overload criteria is not satisfied for the workload within the time interval, for a given workload, the concurrency manager 218 performs an action effective to scale-up parallelism for processing tasks of the workload.

As used herein, “scaling up” refers to an increase in parallelism—e.g., an increase in the number of concurrently active parallelizable tasks—while “scaling down” refers to a decrease in parallelism—e.g., a reduction in the number of concurrently active parallelizable tasks. Notably, different implementations of the disclosed technology may implement different congestion control algorithms for scaling parallelism up or down, respectively, in response to the feedback signals received from the quota service 110.

One implementation of the disclosed technology that enables fair-sharing of quota between different workloads of the same tenant provides for scaling up linearly and scaling down multiplicatively. For example, a workload's task parallelism is increased by a set quantity (e.g., by adding an additional parallel task stream) when the feedback signals associated with the workload do not, over a given observation window, collectively include more than a threshold number of overload indicator(s). This up-scaling within each active workload of the tenant has the effect of equally increasing the resource utilization of each of the tenant's different workloads (e.g., by promoting a substantially linear increase in utilization across the workloads) so long as the tenant's total resource consumption remains safely below the tenant's allotted quota. This logic automatically drives the tenant's quota toward saturation.

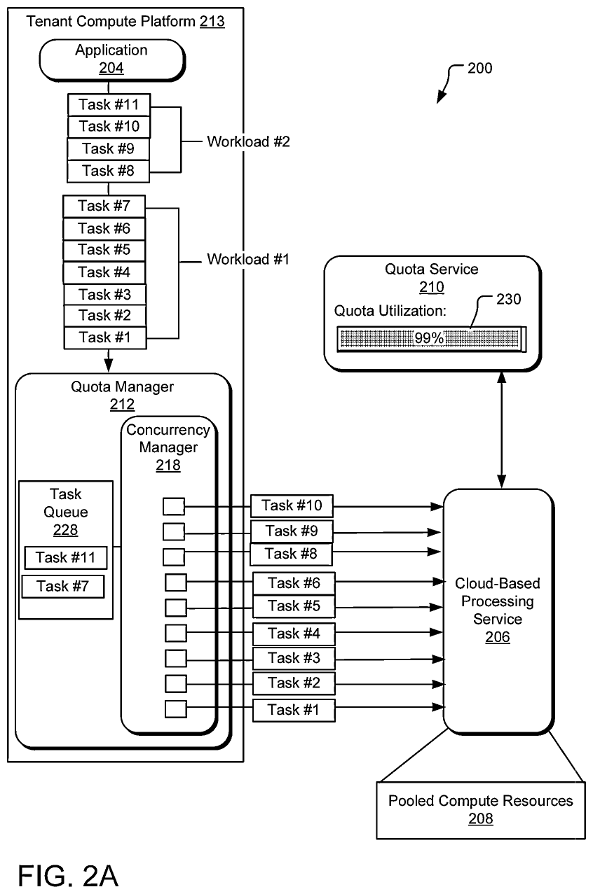

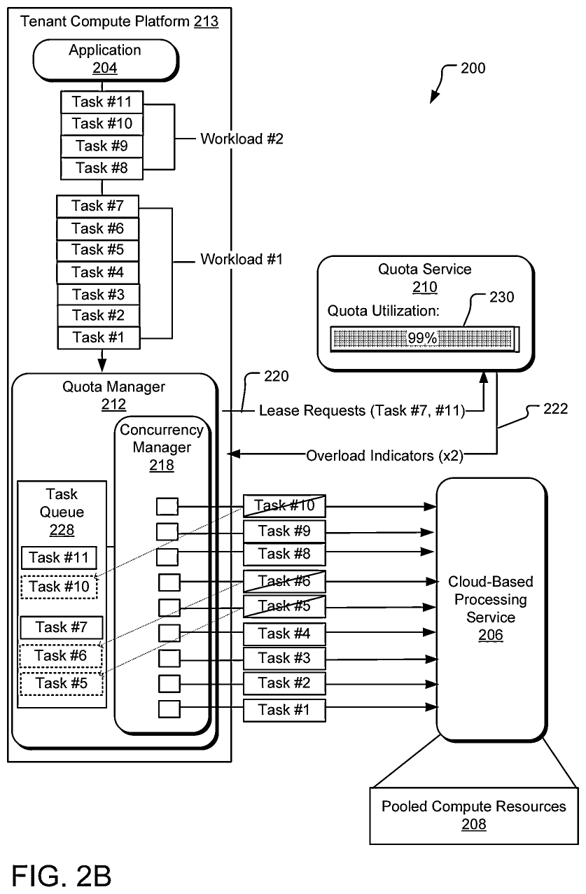

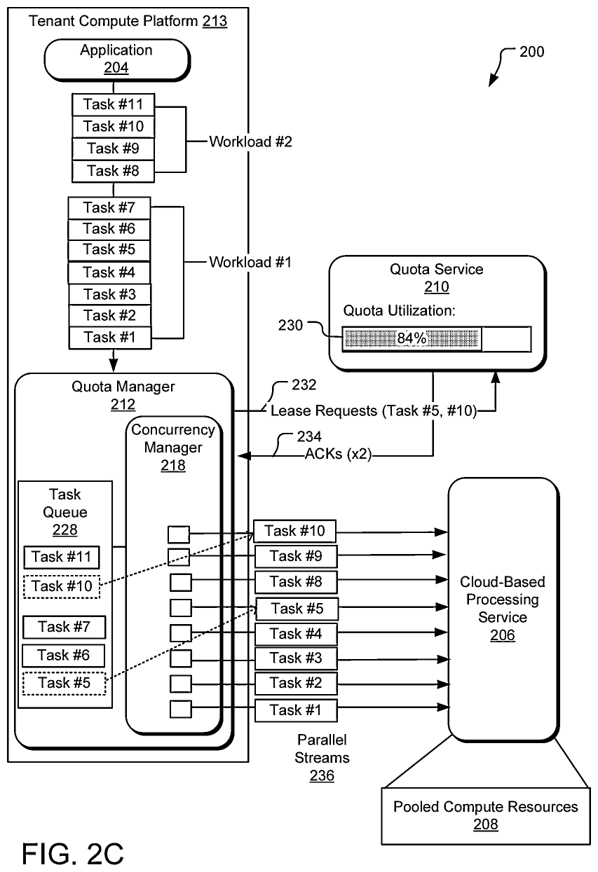

In the same or another implementation, a workload's task parallelism is decreased multiplicatively when the associated feedback signals received during the observation window include at least a threshold number of the overload indicators. In different implementations, workload parallelism is decreased by a select factor multiplied by the workload's total number of active parallel tasks (streams) or in proportion to the workload's total net resource utilization. The foregoing is referred to herein as a “multiplicative decrease in workload parallelism,” and some specific examples of multiplicative decreases in workload parallelism are provided with respect the discussion of FIG. 2B below. This multiplicative decrease in workload parallelism impacts larger-capacity workloads more than smaller-capacity workloads, which has the effect of driving the per-workload utilization toward equilibrium over multiple cycles of linear increase followed by multiplicative decrease. Specific advantages of this dynamic scaling are more easily understood with reference to the examples provided in the following figures.

FIG. 2A-2C illustrates quota management operations performed within an example system 200 that dynamically adjusts task parallelism to achieve congestion control and automatic saturation of compute resource quotas allocated from a shared resource pool.

The system 200 includes several of the same software components as those described above with respect the system 100 of FIG. 1. In particular, the system 200 includes an application 204 that generates workloads for processing by a cloud-based processing service 206, which in one implementation includes an instance of a trained machine learning model. FIG. 2A illustrates two example workloads that have been submitted, on behalf of a tenant, for processing by the cloud-based processing service 206. Each workload individually includes a number of parallelizable tasks. Although actual workloads may be much larger, the simplified example of FIG. 2A-2C features includes a first workload (workload #1) with seven different parallelizable tasks (e.g., tasks #1-#7) and a second workload (workload #2) with 4 different parallelizable tasks (e.g., tasks #8-#11). In this example, the two workloads are shown being as generated by a same application 204 that executes on a tenant compute platform 213, which may be understood as including cloud compute hardware configured on behalf of a tenant and/or edge device hardware in possession of the tenant.

Notably, the quota management operations discussed below with respect to these two workloads are performed on a per-workload basis-meaning, it is possible to implement the same per-workload logic to manage traffic for many different workloads of a same tenant, even if those workloads are submitted by different applications and/or different client devices associated with a requesting tenant.

Take, for example, the scenario where a given development team is allocated a set quota from a group of pooled compute resources 208. Different users from the team may launch different jobs that run on different devices, but all share the same quota. In this case, each different client device used by a member of the team executes a different instance of the application 204 and the quota manager 212. Regardless of whether there exists one instance of the quota manager 212 or multiple instances of the quota manager 212 executing on behalf of a given tenant, the quota manager 212 executes congestion control logic on a per-workload basis (e.g., without communicating with other instances of the quota manager 212 handling other workloads of the tenant) as discussed below.

The cloud-based processing service 206 is, in one implementation, a large-scale machine learning model, such as an LLM with the same or similar characteristics as those described with respect to the cloud-based processing service 106 of FIG. 1. Compute resources of the cloud-based processing service 206 are pooled and collectively referred to as “pooled compute resources 208.”

As mentioned above, the application 204 executes on behalf of a specific tenant (e.g., a development team) to the pooled compute resources 208. The tenant been allocated a utilization quota representing a set fractional share of those resources that can be utilized simultaneously. Prior to transmission of the generated workloads #1, #2 to the cloud-based processing service 206, the generated workloads are provided to a quota manager 212. It should be understood that in alternate scenarios where the workloads are generated on different devices associated with the tenant, the different workloads are submitted to different instances of the quota manager 212.

The quota manager 212 identifies the individual parallelizable tasks within each workload that it receives and communicates with a quota service 210 to request a resource “lease” in association with each different one of the tasks. The quota service 210 provides the same or similar functionality as that described above with respect to FIG. 1—namely, communicating with the cloud-based processing service 206 to discover capacity characteristics of the pooled compute resources 208 as well as tracking utilization of the pooled compute resources 208 by each different tenant in view of a quota allocated to each tenant.

In the example illustrated, the quota manager 212 has already requested a resource lease in association with all of tasks 1-6, of workload a #1, and of 8-10, of workload #2. For each one of these previously-received lease requests, The quota service 210 determined that each one of these previously-received lease requests could be granted without exceeding the tenant's quota. Consequently, tasks 1-6 and 8-10 have been transmitted to the cloud-based processing service 206 in parallel streams and are concurrently being processed. Tasks #7 and #11 are both pending in a task queue 228 and awaiting lease assignment.

FIG. 2B illustrates congestion control operations performed in the system 200 in response to the actions illustrated and described with respect to FIG. 2A. Here, the quota manager 212 transmits two separate lease requests (shown by combination arrow 220) to the quota service 210. The first of these two lease requests pertains to pending task #7 of workload #1 while the second of these two lease requests pertains to pending task #11 of workload number #2. The quota service 210 evaluates the first lease request pertaining to task #7 and determines that an amount of compute capacity (e.g., the net resource utilization) specified in the corresponding lease request would, if granted, exceed the tenant's quota by pushing the utilization of the quota from 99% (as shown) to over the 100% mark. Consequently, the quota service 210 responds to the lease request for task #7 with a feedback signal including an overload indicator. The quota service 210 next evaluates the second lease request pertaining to task #11 and determines that the amount of compute capacity specified in the corresponding lease request would also exceed the tenant's quota. The quota service 210 therefore responds to the second lease request with a feedback signal including another overload indicator (e.g., where combination arrow 222 indicates the successive feedback signals that each have the overload indicator present).

The quota manager 212 conveys the two, consecutively-received overload indicators to the concurrency manager 218, which is configured to perform the same or similar actions as those described with respect to the concurrency manager 118 of FIG. 1.

In one implementation, the concurrency manager 218 observes and counts overload indicators associated with each active workload over an observation window of set length (a rolling time interval) and, at the end of each window, performs a dynamic scaling action to adjust task parallelism of the workload(s) based on whether or not the observed and counted overload indicators satisfy overload criteria (examples of which are discussed further below). Assume, in the illustrated example, that the overload indicators shown by combination arrow 222 were received within a same observation window (e.g., a 3-minute window). At the end of the observation window, the concurrency manager 318 counts the number of overload indicators received with respect to each different workload and based on this evaluation, makes a scaling decision with respect to each different workload.

In one implementation, the concurrency manager 218 scales back task parallelism a workload (e.g., workload #1, workload #2) each time the feedback signals associated with a workload satisfy overload criteria for a given observation window. For example, the overload criteria is satisfied when a threshold number of overload indicator(s) are observed in association with the workload during the corresponding observation window.

Returning to the example of FIG. 2B, the concurrency manager 218 determines—based in part on the overload indicators corresponding to tasks #7 and #11—that the overload criteria is satisfied with respect to both of workloads #1 and #2. Consequently, the concurrency manger 218 multiplicatively decreases the task parallelism of both workloads. In this example, parallelism is decreased given by fractional multiplier of the current number of parallel tasks being executed on behalf of each workload.

Although actual scale-down factors may vary from one implementation to another, the example of FIG. 2B illustrates a one-third decrease in parallelism for each of the two workloads. In this example, workload #1 previously had six parallel active tasks and workload #2 previously had three active parallel tasks. Consequently, a one-third reduction in parallelism causes two of the previously-active tasks from workload #1 (e.g., tasks #5 and #6) to be halted and one of the previously-active tasks from workload #2 (task #10) to be halted. These halted tasks (e.g., #5, #6, and #10) are re-added to the task queue 228 for later processing.

Following the one-third reduction in the number of active tasks executing on behalf of each of the two illustrated workloads, tasks #1-4 remain active on behalf of workload #1 and tasks #8-9 remain active on behalf of workload #2. Tasks #5, #6, and #10 have been re-added to the task queue 228 and await execution, along with tasks #7 and #11, which were queued throughout the operations described above with respect to FIG. 2A.

In some implementations, the above-described multiplicative decrease in parallelism is not implemented based on a fractional multiplier of the number of parallel tasks in the workload (e.g., halting 2 of 6 active tasks when ⅓ is selected as the multiplier) but instead as a multiple of the total resource utilization of the workload.

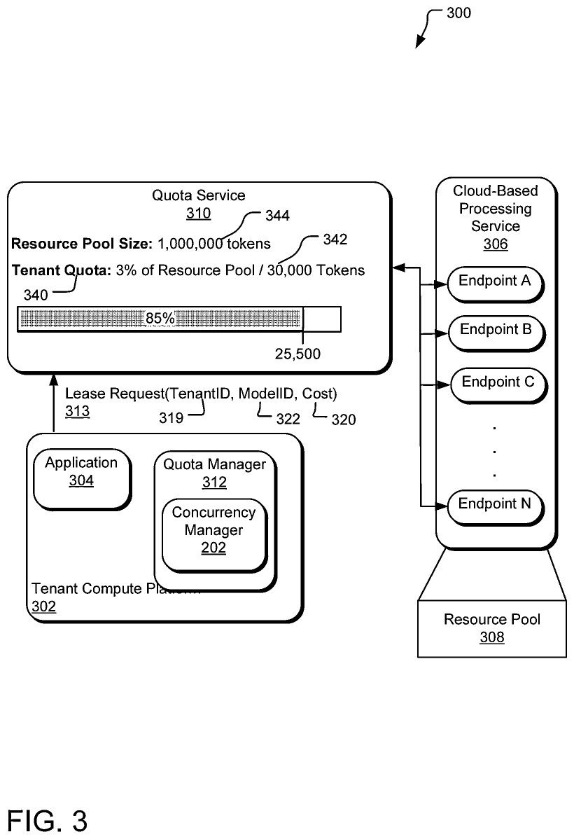

Notably, different tasks may be of different sizes, with some taking longer than others to execute. The aim of this logic is to reduce the cumulative resource utilization of a workload by a set fractional amount rather than by a set number of streams. If, for example, a workload has 4 active parallel tasks with a collective net resource utilization of 1000 tokens (an arbitrary unit type discussed more with respect to FIG. 3A), a one-third reduction in task parallelism translates to a reduction in the number of active parallel tasks that is dependent upon the net resource utilization of each individual task and that is sufficient to ensure a remaining number of active parallel tasks after the reduction have a collective net resource utilization of 666, which is two-thirds of the previous utilization. In this implementation, the concurrency manager 218 decreases task parallelism associated with each different active workload of the tenant by an amount sufficient to achieve a resource utilization decrease for the workload that is a constant multiplier of the workload's previous utilization. For example, the resource utilization of each of 100 workloads is reduced by 10%, 33%, or some other fractional amount.

The above-described logic for multiplicatively reducing workload parallelism (e.g., as either a multiple of the number of streams in the workload or of the workloads' total resource utilization) ensures that reductions in parallelism do not disproportionally affect any individual workload. Due to this multiplicative decrease logic, the larger workloads that initially account for a greater fraction of a tenant's resource utilization quota are impacted by greater decreases in utilization than smaller workloads. Over time, this logic “evens out” the utilization of the quota among all workloads, furthering the goal of quota fair-sharing among different workloads of a same tenant.

FIG. 2C illustrates congestion control operations performed in the system 200 in response to the actions illustrated and described with respect to FIGS. 2A and 2B. After scaling down task parallelism for each workload by one-third of the previous number of parallel streams, the utilization of the tenant has dropped from 99% of the allotted quota to 84% (e.g., as shown by quota utilization bar 230). Next, quota manager 212 transmits two more sequential lease requests (shown by combination arrow 232) for pending tasks #5 and #10. The quota service 210 evaluates each lease request in turn and determines, based on the net resource utilization specified in each of the lease requests and the known quota allotted to the tenant, that each lease request can be granted without exceeding the allotted quota for the associated tenant. In response to each such determination, the quota service 210 transmits a feedback signal including an acknowledgement, indicating that the lease request has been granted. The quota manager 212 therefore receives two acknowledgements, indicated by combination arrow 324.

In one implementation, the concurrency manager 218 immediately scales up parallelism in response to receiving an acknowledged lease request. For example, tasks #5 and #10 may be sent to the cloud-based processing service 206 as soon as their associated lease requests are granted. However, in another implementation, the concurrency manager 218 maintains a constant number of parallel tasks with respect to each different workload until the end of a given interval, during which time overload indicators are observed counted. For example, overload indicators are observed and counted over another 3-minute time interval, and parallelism is linearly increased (e.g., by a set number of streams or utilization quantity) with respect to each workload that did not observe the threshold number of overload indicators during the time interval.

Notably, the illustrated logic can be extended across any number of workloads for a given tenant. Each time an observation window terminates with fewer than a threshold number of overload indicators being observed for the workload, parallelism is linearly increased for the workload. A cumulative effect of these additive increases in task parallelism with respective to different active workloads of a tenant is that resource utilization is steadily and substantially uniformly increased across all active workloads of a same tenant. These additive increases to task parallelism ensure that a tenant's quota is consumed proportionally (e.g., equally divided) between each different active workload of the tenant. Although different implementations may employ a number of differently-sized linear increases and multiplicative decreases consistent with the above-described logic, one implementation provides for increasing the parallelism of a workload by one additional parallel stream each time the workload's overload indicator rate is below a threshold for a given observation interval and for decreasing the parallelism of the workload by one-third of the previous parallelism rate (e.g., a decrease of one-third multiplied by the number of currently active streams) when the workload's overload indicator rate is above the threshold.

FIG. 3 illustrates additional quota management actions within another example system 300 that dynamically adjusts task parallelism to achieve congestion control and automatic saturation of compute resource quotas allocated to tenants in a shared resource system. The system 300 includes manage of the same software components as those described above with respect to FIGS. 1-2C including a tenant compute platform 302 that executes an application 304 that generates workloads (not shown) to be processed by a cloud-based processing service 306 which is, for example, a processing service that provides one or multiple instances of a trained machine learning model, such as a transformer-based model trained to perform NLP tasks. In FIG. 3, the cloud-based processing service 306 includes multiple endpoints (e.g., endpoints A through N), each of which execute instances of a same AI model and that include compute resources allocated to a shared resource pool 308. The resources within the shared resource pool 208 are shared among tenants that submit processing jobs to the AI model.

In addition to the application 304, the tenant compute platform 302 includes a quota manager 312 and a concurrency manager 318, each of which perform actions and provide functionality the same or similar to the actions and functionality attributed to like-named components described elsewhere herein.

For each parallelizable task generated by the application 304 for submission to the cloud-based processing service 306, the quota manager 312 transmits a lease request 316 to the quota service 310. The lease request 313 includes at least a tenant ID 319 that identifies the requesting tenant (e.g., the application 304) and a net resource utilization 320 identifying an estimated capacity utilization associated with execution of the corresponding task. In implementations where the quota service 310 performs quota management for multiple different shared resource pools (e.g., pools associated with different large AI models) each lease request may further specify a specific resource pool and/or target model (e.g., model ID 322) that is to receive and process the task.

The quota service 310 communicates with various different endpoints of the cloud-based processing service 306 to determine capacity characteristics of each endpoint (e.g., how much compute capacity resides at the endpoint as well as the available compute capacity at the endpoint at the current point in time). The quota service 310 locally stores and (frequently re-retrieves and updates) these capacity characteristics, including a pool capacity 344 quantifying the current compute capacity of the shared resource pool 308. Additionally, the quota service 310 stores quota information 340 associated with each tenant to the managed resource pool(s). In the example of FIG. 3, the quota information 340 identifies a fractional percentage of a shared resource pool allocated to the tenant as well as a numerical quota 342 quantifying the compute capacity associated with that fractional percentage at the given point in time.

In one implementation, the pool capacity 344 and the numerical quota are both representing using a same type of unit (“tokens”) as the net resource utilization 320 that is specified in the lease request 313. These tokens represent one of many possible units that may be employed to facilitate an accurate comparison of the relative amount of capacity consumed in executing each, providing that consumed capacity directly corresponds to a known amount of compute capacity in the in the shared resource pool 308.

In the implementation shown, the cloud-based processing service 306 is an LLM that performs NLP tasks. Here, “tokens” correspond to a number of individual words processed by the LLM, with each individual token representing the compute power that it takes for the model to process one word. For example, each NLP processing task has an input consisting of a known number of words (e.g., “Generate a travel itinerary for a three-day trip to Paris,” which is 10 words) and an output consisting of a predicted number of words. The number of words in the output can be predicted in various ways, such as by modeling a bell curve of inputs and outputs to the model associated with a same set of parameters or by employing other suitable methodologies readily known in the LLM field. These known prediction methods are, in some cases, employed to select an output size that represents a cap on the number of words that the LLM is to return. For example, the application 304 and/or the quota manager 312 analyzes the size of the request input and the parameters specified to determine that the median model output size is 450 words and then set the estimated model outputs at some value above the median, such as one or two sigma above the median.

In one implementation employing the above methodology to quantify compute capacity and consumption, the net resource utilization 320 specified in each lease request is a sum of the number of input words included in the model input and the number of output requested by the application that generated the task. If, for example, the LLM task entails processing 10 words of input and the application 304 requests up to 300 words of output, the net resource utilization of the task is 310 tokens. This same unit type can likewise be used to quantify the compute resources in an available resource pool (e.g., where 1 token equates to the processing power that it takes the LLM to process 1 word of input/output).

The quota service 310 periodically queries the endpoints of the cloud-based processing service 306 (e.g., the LLM), such as in response to each lease request, in order to re-discover and update the capacity characteristics of the associated shared resource pool. In the event that servers are added to or removed from the shared resource pool 308, the quota service 310 detects the change and, in response, updates the pool capacity 344 to reflect the capacity change. In this scenario, the numerical quota 342 is re-computed for the tenant based on the tenant's allotted fractional percentage of the pool.

When the numerical quota 342 changes, such as due to a reduction in physical compute resources in the shared resource pool 308, the quota service 310 implements its quota enforcement logic consistent with the updated value. That is, the quota service 310 grants or denies lease requests based on the updated value of the numerical quota 342, such as using the same or similar logic and feedback signals as those described with respect to any of FIG. 1 or 2A-2C.

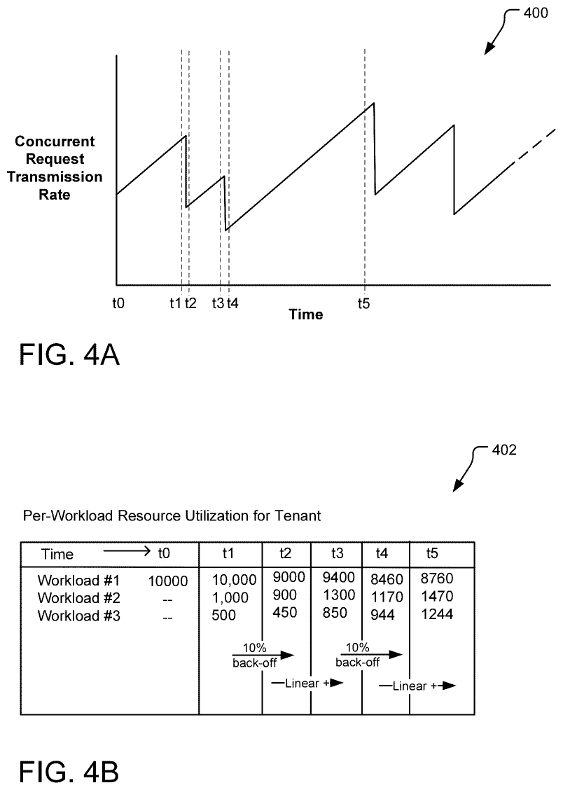

FIG. 4A illustrates a plot 400 illustrating temporal changes in concurrent request transmission rate from a tenant device submitting jobs to a large cloud-based AI model. Trends visible in the plot 400 are discussed below with reference to utilization data shown in FIG. 4B. Specifically, FIG. 4B illustrates resource utilization costs 402 for various exemplary workloads of the tenant device that are characterized by the concurrent request transmission rate trends shown in FIG. 4A.

As shown in FIG. 4a, the tenant device steadily increases the concurrent request transmission rate (e.g., tasks parallelism) between times t0 and t1. FIG. 2B shows that at the time t0, the active tasks in workload #1 have a collective net resource utilization of 10,000 tokens. As workloads #2 and #3 are submitted between times t0 and t1, the tenant device submits lease requests for tasks pertaining to these workloads in a fair (e.g., round-robin) additive manner so as to affect a linear increase in the resource utilization that is substantially uniform across all three workloads. This additive increase in parallelism continues so long as the overload indicator rate (e.g., number of overload indicators received in a threshold period of time) does not, for any of the active workloads, satisfy overload criteria-such as by exceeding a set threshold.

Although overload indicators are, in some implementations, monitored and counted with respect to each workload individually (e.g., without communications between workloads and/or aggregation of data collected with respect to different workloads), it is to be appreciated that all workloads of a tenant are likely to observe a similar increase in the overload indicator rate when the tenant's resource consumption is at or very near the quota limit. Consequently, reductions in task parallelism are implemented across different workloads of a tenant at the same or very similar points in time.

The plot 400 shows a scenario the overload indicator rate exceeds the permissible threshold with respect to workload #1, #2, and #3 at substantially the same time (e.g., just after t1). The tenant device responds by reducing task parallelism of each of the workloads multiplicatively—e.g., either by a multiple of the workload's number of active parallel tasks or by a multiple of the workload's total resource utilization.

In the example shown, a 10% multiplicative decrease in task parallelism is implemented for each workload individually. This is reflected in the resource utilization costs 402 of FIG. 4B by the 10% drop in utilization between t1 and t2. This 10% utilization reduction effectively drops the net resource utilization of active tasks for workload #1 from 10,000 tokens to 9,000 tokens. Similar 10% reductions are shown for workload #2 (dropping from 1000 to 900 tokens) and workload #3 (dropping from 500 to 450 tokens).

Following the time t2, the tenant's utilization is again safely below the maximum utilization permitted (e.g., the quota cap). Consequently, the tenant device continues to steadily increase task parallelism in a linear manner that is substantially equal across the three workloads until such time that the overload indicator rate again spikes above the permissible threshold for the various workloads. This linear increase in task parallelism is shown in FIG. 3B by identical 400 token increases in the net resource utilization of each of the three workloads between time t2 and time t3.

When the overload indicator rate again exceeds the permissible threshold just after the time t3, the tenant device responds by again multiplicatively decreasing task parallelism to achieve a 10% decrease in the utilization of all three workloads. FIG. 3B illustrates this second 10% back-off via the 10% reduction in the resource utilization costs between t3 and t4. Following this, the tenant's utilization is again safely below the maximum utilization permitted. Consequently, the tenant device again increases task parallelism in an additive manner so as to affect a substantially identical utilization increase across all three workloads between times t4 and t5.

The above-described operations are repeated in indefinitely with the tenant device imposing additive linear increases across all active workloads so long as each lease request is approved and imposing a multiplicative decrease in task parallelism (e.g., as a factor of each workload's utilization rate) whenever an overload indicator is received. Over time, these additive increases and multiplicative decreases drive the various active workloads of the tenant device toward a substantially equal utilization of the tenant's allotted quota. Although the resource utilization costs 402 represents just two back-off adjustments and two rounds of additive increase, it can be appreciated that this data does exemplify a convergence trend in the per-workload utilization rate. At time t1, active tasks in workload #1 have a net resource utilization amount to 10× the utilization rate of workload #2; yet, by time t5 this gap has reduced such that workload #1 is utilizing 6× the compute resources of workload #2. Similarly, the active tasks in workload #2 initially amount to a net resource utilization that is 2× the utilization of workload #1; by time t5, this gap is reduced such that workload #2 is 1.18× the utilization of workload #2. One can appreciate how, over time, the above methodology evens-out the tenant's utilization out across the three workloads until eventually, the utilization ratio is 1:1:1 (each workload using ⅓ of the quota).

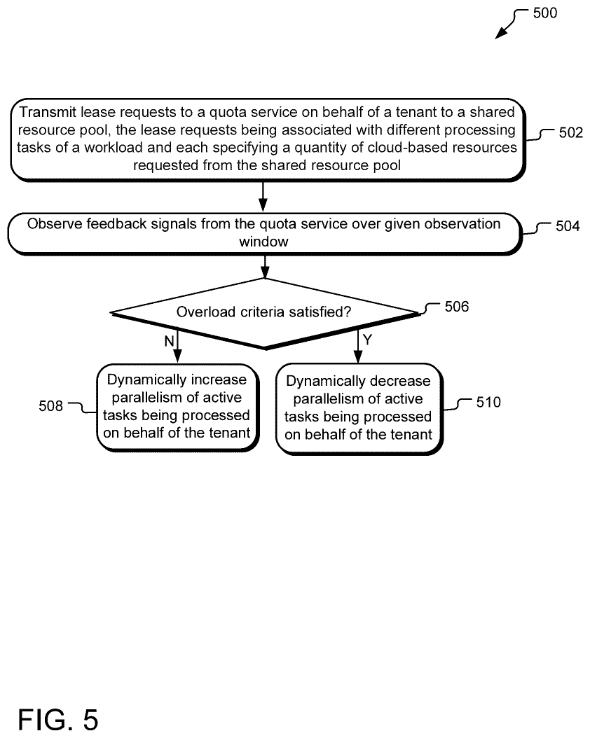

FIG. 5 illustrates example congestion control operations 500 for automatic saturation of compute resource quotas allocated from a shared resource pool. According to one implementation, the congestion control operations 500 are performed by a quota manager executing on a client. A client application executing on the tenant device generates workloads (e.g., batch jobs) for execution by a cloud-based AI model, such as an LLM. The client application is a tenant to a pool of compute resource shared by other tenants also requesting services of the same cloud-based AI model. Each different tenant to the pool is allotted a quota of total available resources in the pool. The quota is not static and may, for various reason, change over time.

Each workload generated by the client application includes parallelizable tasks. The tenant device dynamically scales how many of these tasks are concurrently executed based on communications with a quota service. Here, “dynamic scaling” refers to an increase or decrease in parallelism that is performed in real-time with respect to a given workload while the workload is executing. For example, between the start and conclusion of workload execution, the number of active parallel tasks may be scaled up and/or down multiple times. The quota service monitors capacity characteristics of the shared resource pool and also monitors the fractional utilization of each tenant's allotted quota over time.

In the example operations 500, a lease request operation 502 transmits multiple lease requests to the quota service on behalf of the tenant. Each of the lease requests is, essentially, a request to reserve compute resources from the shared resource pool on behalf of a particular one of the parallelized tasks for a tenant workload. The request identifies the requesting tenant and also includes a net resource utilization associated with execution of the corresponding task. An observation operation 504 observes feedback signals received from the quota service over a given observation window. Each one of the feedback signals includes information indicating whether grant of a corresponding one of the lease requests would cause the tenant to exceed a resource quota limit allocated to the tenant. In scenarios where grant of the lease request would exceed the tenant's resource quota limit, the feedback signal includes an overload indicator.

Based on the observed feedback signals, a determination operation 506 determines whether the feedback signals satisfy overload criteria with respect to the tenant workload. When it is determined that the overload criteria is not satisfied, a concurrency rate increase operation 508 increases the task parallelism of the workload.

In scenarios where the determination operation 506 determines that the feedback signals do satisfy the overload criteria, a concurrency rate decrease operation 510 decreases the task parallelism for the workload. In one implementation, this decrease in task parallelism is implemented as a multiplicative decrease that depends on the total resource utilization of the workload that the requested task pertains to. In another implementation, this decrease in task parallelism is implemented as a multiplicative decrease that depends on the total number of parallel tasks being executed on behalf of the workload. In either implementation, this multiplicative decrease logic tends to affect a larger utilization decrease for larger workloads than for smaller workloads. In time, the above logic-generally providing for multiple alternating additive increases and multiplicative decreases to task parallelism-drives the tenant's quota utilization toward a distribution evenly split across all active workloads of the tenant.

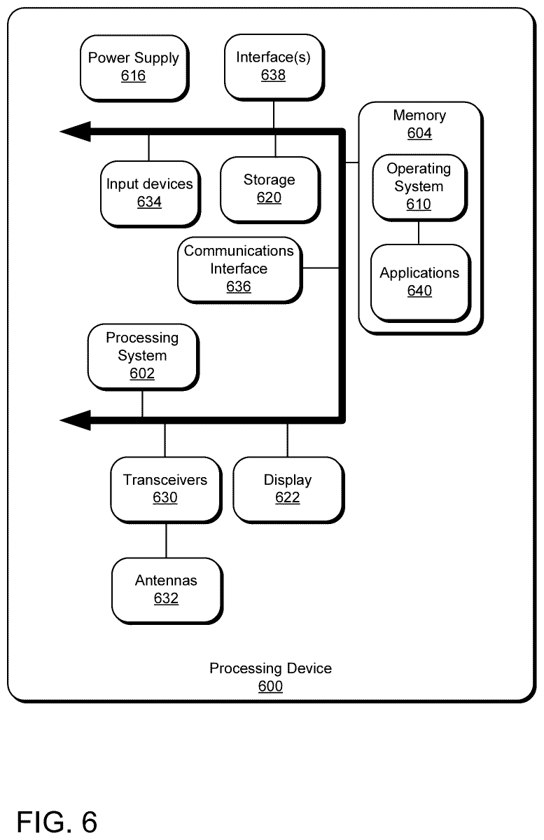

FIG. 6 illustrates an example schematic of a processing device 640 suitable for implementing aspects of the disclosed technology. The processing device 600 includes one or more processor unit(s) 602, memory device(s) 604, a display 606, and other interfaces 608 (e.g., buttons). The processor unit(s) 602 may each include one or more CPUs, GPUs, etc.

The memory device(s) 604 generally includes both volatile memory (e.g., RAM) and non-volatile memory (e.g., flash memory). An operating system 610, such as the Microsoft Windows® operating system, the Microsoft Windows® Phone operating system or a specific operating system designed for a gaming device, resides in the memory device(s) 604 and is executable by the processor unit(s) 602, although it should be understood that other operating systems may be employed.

One or more applications 612 (e.g., the application 104 of FIG. 1, the quota manager 112 of FIG. 1, the quota service 110, or a cloud-based AI model such as the cloud-based processing service 106 FIG. 1) are loaded in the memory device(s) 604 and executed on the operating system 610 by the processor unit(s) 602. The applications 612 may receive inputs from one another as well as from various input local devices such as a microphone 634, input accessory 635 (e.g., keypad, mouse, stylus, touchpad, gamepad, racing wheel, joystick), and a camera 632. Additionally, the applications 612 may receive input from one or more remote devices, such as remotely-located smart devices, by communicating with such devices over a wired or wireless network using more communication transceivers 630 and an antenna 638 to provide network connectivity (e.g., a mobile phone network, Wi-Fi®, Bluetooth®). The processing device 600 may also include one or more storage devices 628 (e.g., non-volatile storage). Other configurations may also be employed.

The processing device 600 further includes a power supply 616, which is powered by one or more batteries or other power sources and which provides power to other components of the processing device 600. The power supply 616 may also be connected to an external power source (not shown) that overrides or recharges the built-in batteries or other power sources.

The processing device 600 may include a variety of tangible computer-readable storage media and intangible computer-readable communication signals. Tangible computer-readable storage can be embodied by any available media that can be accessed by the processing device 600 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a method for congestion control that increases utilization of compute resources in a shared resource pool, the method including: transmitting lease requests to a quota service on behalf of a tenant to the shared resource pool, the lease requests being associated with various processing tasks and specifying quantities of cloud-based resources requested from the shared resource pool; observing feedback signals from the quota service for a time interval, the feedback signals each indicating whether grant of a corresponding one of the lease requests would cause the tenant to exceed a resource quota limit allocated to the tenant; and dynamically decreasing parallelism of active tasks being processed by the cloud-based resources on behalf of the tenant if the feedback signals satisfy overload criteria within a given time interval; and dynamically increasing parallelism of the active tasks being processed by the cloud-based resources on behalf of the tenant if the feedback signals do not satisfy the overload criteria within the given time interval.

In some aspects, the techniques described herein relate to a method, wherein observing the feedback signals further includes: detecting an overload indicator within a select one of the feedback signals corresponding to a lease request that would cause the tenant to exceed the resource quota limit.

In some aspects, the techniques described herein relate to a method, wherein the overload indicator indicates denial of the lease request and wherein the feedback signals satisfy the overload criteria when a threshold number of overload indicators are received in the given time interval.

In some aspects, the techniques described herein relate to a method, wherein the various processing tasks are associated with a workload and wherein dynamically decreasing parallelism of the active tasks further includes decreasing task parallelism for the workload.

In some aspects, the techniques described herein relate to a method, wherein dynamically decreasing parallelism for the workload achieves a multiplicative decrease in at least one of total utilization of compute resources by the workload and a number of parallel tasks being executed on behalf of the workload.

In some aspects, the techniques described herein relate to a method, wherein dynamically increasing parallelism of the active tasks includes additively increasing task parallelism for the workload.

In some aspects, the techniques described herein relate to a method, wherein the shared resource pool includes graphics processing units (GPUs) dedicated to supporting a transformer model trained to perform natural language processing (NLP) tasks.

In some aspects, the techniques described herein relate to a congestion control system that increases utilization of compute resources in a shared resource pool including, the congestion control system including: a quota manager stored in memory and executable to: receive, from a tenant to the shared resource pool, a request for processing of a workload by a transformer model; transmit multiple lease requests to a quota service on behalf of the tenant, the multiple lease requests being associated with processing tasks of the workload and specifying quantities of cloud-based resources requested from the shared resource pool associated with the transformer model; observe feedback signals from the quota service for a time interval, the feedback signals each tenant to exceed a resource quota limit allocated to the tenant in association with the shared resource pool; and in response to determining that the feedback signals satisfy overload criteria, dynamically decrease task parallelism of the workload being processed by the cloud-based resources on behalf of the tenant.

In some aspects, the techniques described herein relate to a congestion control system, wherein the feedback signals corresponding to denied lease requests include overload indicators.

In some aspects, the techniques described herein relate to a congestion control system, wherein the feedback signals satisfy the overload criteria for the workload when a threshold number of the overload indicators are received in association with the workload in a set period of time.

In some aspects, the techniques described herein relate to a congestion control system, wherein the quota manager is further configured to dynamically increase parallelism of active tasks being processed by the cloud-based resources on behalf of the tenant in response to determining that the feedback signals fail to satisfying overload criteria.

In some aspects, the techniques described herein relate to a congestion control system, wherein dynamically decreasing parallelism for the workload achieves a multiplicative decrease in total utilization of compute resources by the workload.

In some aspects, the techniques described herein relate to a congestion control system, wherein dynamically decreasing parallelism for the workload achieves a multiplicative decrease in a number of parallel tasks being executed on behalf of the workload.

In some aspects, the techniques described herein relate to a congestion control system, wherein the congestion control system imposes adjustments to parallelism of active workload tasks within a client compute platform executing an application that generates the workload.

In some aspects, the techniques described herein relate to one or more tangible computer-readable storage media encoding computer-executable instructions for executing a computer process that increases utilization of compute resources in a shared resource pool including, the computer process including: transmitting lease requests to a quota service on behalf of a tenant to the shared resource pool, the lease requests being associated with various processing tasks and specifying quantities of cloud-based resources requested from the shared resource pool; observing feedback signals from the quota service for a time interval, the feedback signals each indicating whether grant of a corresponding one of the lease requests would cause the tenant to exceed a resource quota limit allocated to the tenant; and based on the feedback signals satisfying overload criteria, dynamically decreasing parallelism of active tasks being processed by the cloud-based resources on behalf of the tenant.

In some aspects, the techniques described herein relate to one or more tangible computer-readable storage media, wherein the feedback signals corresponding to denied lease requests include overload indicators.

In some aspects, the techniques described herein relate to one or more tangible computer-readable storage media, wherein the feedback signals satisfy the overload criteria when a threshold number of overload indicators are received in a set period of time.

In some aspects, the techniques described herein relate to one or more tangible computer-readable storage media, wherein the various processing tasks are associated with a workload and wherein dynamically decreasing parallelism of the active tasks further includes decreasing task parallelism for the workload.

In some aspects, the techniques described herein relate to one or more tangible computer-readable storage media, wherein dynamically decreasing parallelism for a workload achieves a multiplicative decrease in at least one of total utilization of compute resources by the workload and a number of parallel tasks being executed on behalf of the workload.

In some aspects, the techniques described herein relate to one or more tangible computer-readable storage media, wherein each of the lease requests includes an application identifier for the tenant and a requested quantity of compute resources to allocate toward execution of a corresponding one of the various processing tasks.

In some aspects, the techniques described herein relate to a congestion control system that increases utilization of compute resources in a shared resource pool including, the congestion control system including a means for receiving, from a tenant to the shared resource pool, a request for processing of a workload by a transformer model; a means for transmitting multiple lease requests to a quota service on behalf of the tenant, the multiple lease requests being associated with processing tasks of the workload and specifying quantities of cloud-based resources requested from the shared resource pool associated with the transformer model; a means for observing feedback signals from the quota service for a time interval, the feedback signals each tenant to exceed a resource quota limit allocated to the tenant in association with the shared resource pool; and a means for dynamically decreasing task parallelism of the workload being processed by the cloud-based resources on behalf of the tenant and in response to determining that the feedback signals satisfy overload criteria.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method for congestion control that increases utilization of compute resources in a shared resource pool, the method comprising:
transmitting lease requests to a quota service on behalf of a tenant to the shared resource pool, the lease requests being associated with various processing tasks and specifying quantities of cloud-based resources requested from the shared resource pool;
observing feedback signals from the quota service for a time interval, the feedback signals each indicating whether grant of a corresponding one of the lease requests would cause the tenant to exceed a resource quota limit allocated to the tenant; and
dynamically decreasing parallelism of active tasks being processed by the cloud-based resources on behalf of the tenant if the feedback signals satisfy overload criteria within a given time interval; and
dynamically increasing parallelism of the active tasks being processed by the cloud-based resources on behalf of the tenant if the feedback signals do not satisfy the overload criteria within the given time interval.

2. The method of claim 1, wherein observing the feedback signals further includes:
detecting an overload indicator within a select one of the feedback signals corresponding to a lease request that would cause the tenant to exceed the resource quota limit.

3. The method of claim 2, wherein the overload indicator indicates denial of the lease request and wherein the feedback signals satisfy the overload criteria when a threshold number of overload indicators are received in the given time interval.

4. The method of claim 1, wherein the various processing tasks are associated with a workload and wherein dynamically decreasing parallelism of the active tasks further includes decreasing task parallelism for the workload.

5. The method of claim 4, wherein dynamically decreasing parallelism for the workload achieves a multiplicative decrease in at least one of total utilization of compute resources by the workload and a number of parallel tasks being executed on behalf of the workload.

6. The method of claim 4, wherein dynamically increasing parallelism of the active tasks includes additively increasing task parallelism for the workload.

7. The method of claim 1, wherein the shared resource pool includes graphics processing units (GPUs) dedicated to supporting a transformer model trained to perform natural language processing (NLP) tasks.

8. A congestion control system that increases utilization of compute resources in a shared resource pool comprising, the congestion control system comprising:
a quota manager stored in memory and executable to:
receive, from a tenant to the shared resource pool, a request for processing of a workload by a transformer model;
transmit multiple lease requests to a quota service on behalf of the tenant, the multiple lease requests being associated with processing tasks of the workload and specifying quantities of cloud-based resources requested from the shared resource pool associated with the transformer model;
observe feedback signals from the quota service for a time interval, the feedback signals each tenant to exceed a resource quota limit allocated to the tenant in association with the shared resource pool; and
in response to determining that the feedback signals satisfy overload criteria, dynamically decrease task parallelism of the workload being processed by the cloud-based resources on behalf of the tenant.

9. The congestion control system of claim 8, wherein the feedback signals corresponding to denied lease requests include overload indicators.

10. The congestion control system of claim 9, wherein the feedback signals satisfy the overload criteria for the workload when a threshold number of the overload indicators are received in association with the workload in a set period of time.

11. The congestion control system of claim 8, wherein the quota manager is further configured to dynamically increase parallelism of active tasks being processed by the cloud-based resources on behalf of the tenant in response to determining that the feedback signals fail to satisfying overload criteria.

12. The congestion control system of claim 8, wherein dynamically decreasing parallelism for the workload achieves a multiplicative decrease in total utilization of compute resources by the workload.

13. The congestion control system of claim 8, wherein dynamically decreasing parallelism for the workload achieves a multiplicative decrease in a number of parallel tasks being executed on behalf of the workload.

14. The congestion control system of claim 8, wherein the congestion control system imposes adjustments to parallelism of active workload tasks within a client compute platform executing an application that generates the workload.

15. One or more tangible computer-readable storage media encoding computer-executable instructions for executing a computer process that increases utilization of compute resources in a shared resource pool comprising, the computer process comprising:
transmitting lease requests to a quota service on behalf of a tenant to the shared resource pool, the lease requests being associated with various processing tasks and specifying quantities of cloud-based resources requested from the shared resource pool;
observing feedback signals from the quota service for a time interval, the feedback signals each indicating whether grant of a corresponding one of the lease requests would cause the tenant to exceed a resource quota limit allocated to the tenant; and
based on the feedback signals satisfying overload criteria, dynamically decreasing parallelism of active tasks being processed by the cloud-based resources on behalf of the tenant.

16. The one or more tangible computer-readable storage media of claim 15, wherein the feedback signals corresponding to denied lease requests include overload indicators.

17. The one or more tangible computer-readable storage media of claim 16, wherein the feedback signals satisfy the overload criteria when a threshold number of overload indicators are received in a set period of time.

18. The one or more tangible computer-readable storage media of claim 15,
wherein the various processing tasks are associated with a workload and wherein dynamically decreasing parallelism of the active tasks further includes decreasing task parallelism for the workload.

19. The one or more tangible computer-readable storage media of claim 17, wherein dynamically decreasing parallelism for a workload achieves a multiplicative decrease in at least one of total utilization of compute resources by the workload and a number of parallel tasks being executed on behalf of the workload.

20. The one or more tangible computer-readable storage media of claim 15, wherein each of the lease requests includes an application identifier for the tenant and a requested quantity of compute resources to allocate toward execution of a corresponding one of the various processing tasks.
